(19) United States
(12) Patent Application Publication
(10) Pub. No.: US 2026/0040002 A1
(43) Pub. Date: Feb. 5, 2026

(54) PROCESSES AND SYSTEMS FOR HEADPHONE TUNING

(71) Applicant: Yellow Matter Entertainment, LLC, Los Angeles, CA (US)

(72) Inventor: Steven Slate Lintz, Los Angeles, CA (US)

(21) Appl. No.: 19/355,616

(22) Filed: Oct. 10, 2025

Related U.S. Application Data
(63) Continuation-in-part of application No. 18/983,324, filed on Dec. 16, 2024.
(60) Provisional application No. 63/611,073, filed on Dec. 15, 2023.

(51) Int. Cl. H04R 3/04; H04R 1/10; H04R 29/00

(52) U.S. Cl. CPC H04R 3/04; H04R 1/1041; H04R 29/001

(57) ABSTRACT

A process for tuning a headphone may include step for loading a desired amplitude value for at least one audio frequency, coupling the headphone to a user so a microphone associated therewith is positioned proximate an ear canal of the user, playing the at least one audio frequency at the desired amplitude value with the headphone, recording a perceived amplitude value for the at least one audio frequency with the microphone, comparing the perceived amplitude value with the desired amplitude value for the at least one audio frequency, and altering play back of the at least one audio frequency to a modified amplitude value the microphone identifies as closer in value to the desired amplitude value than the perceived amplitude value.

### BACKGROUND

The present invention generally relates to processes and systems for headphone tuning. More specifically, the processes and systems for headphone tuning disclosed herein includes an audio tuning interface that enables a user to alter the sound profile of music played back through headphones to more closely match the auditory perception intended by the manufacturer based on the unique ear anatomy of the user.

Headphones are audio devices designed to be worn over or in the cars to listen to sound from electronic devices like smartphones, computers, music players, or other audio sources. Headphones convert electrical audio signals into sound that the user can hear, typically through small speakers (drivers) positioned near or in the cars. Earbuds are a type of headphones that are designed to fit snugly into the folds of the outer ears to stay in place while small nozzles having the speakers, and covered by elastic ear-tips creating a seal with the ear canal openings, extend into the ear canals. The clastic ear-tips help form a seal with the inside of the ear canals to help block outside noise and deliver sound more directly from the speaker nozzles surrounded by the plastic ear-tips into the ear canal.

The speakers (drivers) of the headphones receive audio signals typically in the form of an electrical current that represents sound. When the audio signals (an alternating electrical current) pass through a voice coil in the speaker, it creates a changing magnetic field that interacts with a permanent magnet therein, and the changing magnetic force causes the voice coil to move back and forth. This movement causes a diaphragm coupled to the voice coil to vibrate, and the vibration of the diaphragm pushes and pulls air to create sound waves. These sound waves travel into the ear and are perceived as sound when the waves vibrate the eardrum. The frequency response the user experiences with respect to the vibrations generated by the speaker is based on how the sound waves generated by the speaker interact with the anatomy of the inner ear, and specifically the ear canal. In this respect, the anatomy of the ear canal is different for each person, including that each person may have a different ear canal anatomy for their right and left cars. As a result of the anatomy of the ear canal being unique for each ear (e.g., with respect to length and diameter), the perceived amplitude of the produced frequency sound waves interacting with the ear canal also tend to be different, especially for sound waves having midrange frequencies between about 1 kHz to 5 kHz.

For decades, headphone manufacturers have attempted to “tune” the sound of their headphones to provide the most detailed and optimized sound to the user. By using certain components in the electronic and mechanical design, manufacturers have attempted to provide each user with a frequency response that is pleasing. Although, unfortunately, it is not possible for a single headphone design to offer the same frequency response to all users because the perceived amplitude of certain frequencies, especially in the midrange frequencies mentioned above, varies depending on the anatomy of the inner ear. Thus, different users of the same set of headphones can have a different and unique listing experience, including that one user may experience sound in one ear that is different from another ear because of differences in the ear canal anatomy. This is because the shape of the inner ear canal directly affects the amplitude that certain frequencies, and the overall frequency response, are perceived by the ear drum.

Anatomical differences of the ear canal (i.e., length and diameter) “customize” the sound profile for all auditory sources for each user, including the perceived frequency response and location of the sound source. When wearing earbuds, the relatively small speakers extending in the ear-tips produce sound directly near the opening of the ear canal. But, given that the perceived sound by the user is correlated with the ear canal anatomy, the auditory perception of a common sound profile will be experienced differently or uniquely by each ear. Thus, it is possible for two users wearing the same headphones and listening to the same audio input to have two completely different experiences because each user has a unique frequency response to the audio based on their ear canal anatomy. This may be especially true for audio frequencies in the range of 1-5 kHz where the unique anatomy of a user's ear canal may modify the produced audio tones to deviate from the desired frequency response. Within such frequency range, the produced audio tone resonating towards the user's eardrum may be altered by the anatomy of the car canal such that the audio amplitude is offset by up to 10 decibels.

It is possible to determine how the frequency response differs within the ear of each listener by measuring a frequency response for each user with an ultra-small microphone placed inside the ear canal, and then comparing the measured frequency response for the user to that of a reference frequency response. In this respect, FIG. 1 illustrates a diagram 10 charting a pair of sine sweeps played through a headphone as experienced by two different users having different inner ear profiles. As shown, there is almost no discrepancy between a sine sweep 12 of the first user and a sine sweep 14 of the second user within the 20 hertz (“Hz”) to 800 Hz range and above 7 kilohertz (“KHz”). Accordingly, all users tend to hear frequencies within these ranges at comparable amplitudes regardless of differences in the ear anatomy. In this respect, FIG. 1 also illustrates that the core differences in perceived tonal amplitude between the sine sweep 12 of the first user and the sine sweep 14 of the second user typically exists above 800 Hz and below 7 kHz, with the largest frequency discrepancies most commonly occurring at about 3.5 kHz. In fact, depending on the respective anatomies of two users, midrange frequencies in the 1.5 kHz to 5 kHz range can deviate up to 10 decibels (“db”). Consequently, two users could listen to the same audio input in a headphone, but one user perceives these midrange frequencies to be much louder or softer than another user. This is problematic for the headphone manufacturer because it is impossible for a headphone to produce a sound profile consistently experienced by all users because the frequency response, i.e., how each user perceives the amplitude of frequencies resonating in the ear canal, is different for each user based on variations of the inner ear anatomy.

There exists, therefore, a significant need in the art for processes and systems for headphone tuning, such as by way of adjusting the amplitude of certain frequencies based on an ultra-miniature microphone recording audio produced by the headphone, and detecting discrepancies between a desired audio tone and an actual audio tone resonating within the ear canal of the user. The present invention fulfills these needs and provides further related advantages.

### SUMMARY

In one embodiment of a process for tuning a headphone, the steps include analyzing a baseline audio profile for a lower range reference frequency and a midrange reference frequency and adjusting an amplitude of the lower range reference frequency to that of an amplitude of the midrange reference frequency. This sets a benchmark where the user can hear the intended amplitude of the midrange reference frequency without changes due to differences in audio resonance within the ear canal.

The next step is to generate a tone at the adjusted amplitude of the lower range reference frequency and a tone at an initial amplitude of a midrange tuned frequency from a user sound profile so the user can hear and compare the differences. Here, the user adjusts the playback of the midrange tuned frequency until the amplitude matches that of the adjusted amplitude of the lower range reference frequency. Thereafter, the initial amplitude of the midrange tuned frequency is modified within the user sound profile by a discrepancy value based on the difference between the adjusted amplitude of the lower range reference frequency and the initial amplitude of the midrange tuned frequency so a modified amplitude of the midrange tuned frequency is closer to the amplitude of the midrange reference frequency than the initial amplitude of the midrange tuned frequency. Making this modification to the user sound profile produces a frequency response experienced by the user that more aligns with the intended audio experience of the manufacturer because the manufacturer set the relationship between the low and medium range baseline.

Additionally, the system may tune the baseline audio profile, which may be used to then map a sine sweep of the baseline audio profile, including the amplitude of the lower range reference frequency and the amplitude of the midrange reference frequency. This mapping of the baseline audio profile may then be used to assign the lower range reference frequency multiple adjusted amplitudes each of which correspond to an amplitude of one of multiple other midrange reference frequencies of the baseline audio profile for use to increase the number of data points taken within the midrange frequencies, which enhances the modification of the user sound profile to track the baseline audio profile more closely. In this respect, the modifying step may further include a step of changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies. Here, each of the multiple other midrange tuned frequencies have a frequency the same as each of the multiple other midrange reference frequencies.

Additionally, in another aspect of these embodiments, the system may automatically select the multiple other midrange tuned frequencies, or the system may enable the user to manually select one or more of the other midrange tuned frequencies by way of a user-interactable interface, such as a touch screen or mixing table having a plurality of assignable faders. Here, the system may then blend the set of discrepancy values to create a user-specific Q filter with a relatively higher resolution mapping the user sound profile to the baseline audio profile because of all the additional datapoints correlating the amplitudes of the midrange tuned frequencies to the amplitudes of the midrange reference frequencies the manufacturer of the headphones intended the user to hear when listen to music, etc. In some embodiments, the lower range reference frequency may include frequencies below 800 Hz, and in more specific embodiments, the lower range reference frequency may be a single frequency within a range of 100 Hz to 500 Hz. Additionally, the midrange reference frequency may be between 800 Hz and 7 kHz, and in more specific embodiments, the midrange reference frequency may be a single frequency within a range of 1 kHz to 5 KHz.

In another aspect of these embodiments, the system may extrapolate multiple other discrepancy values assignable to multiple other midrange tuned frequencies based on the discrepancy value set by the user during testing, the baseline audio profile, and the user sound profile. Here, the system may modify these multiple other midrange tuned frequencies with the extrapolated discrepancy values in an effort to better track the audio playback of the user sound profile to that of the baseline audio profile, without requiring the user to manually configure multiple of the midrange tuned frequencies. Here, the extrapolating step may include assigning a new amplitude to each of the multiple other midrange tuned frequencies in the user sound profile based on an average sine sweep. Alternatively, the extrapolating step may include progressively decreasing the multiple other discrepancy values for each of the multiple other midrange tuned frequencies intermittently backwards from 3.5 kHz to 1 kHz and forwards from 3.5 kHz to 6 kHz. In this latter embodiment, the user may attempt to tune a midrange tuned frequency having the largest discrepancy (e.g., 10 db at 3.5 kHz), whereby the system can then generally step down the discrepancy value to help close the amplitude gap between the user sound profile and the baseline audio profile for multiple of the midrange frequencies.

When the user is comparing the amplitudes of the adjusted amplitude of the lower range reference frequency and the initial amplitude of the midrange tuned frequency, the system may pulse the tone of the midrange tuned frequency in between playing the tone of the lower range reference frequency. Alternatively, the generating step may include playing the lower range reference frequency and the midrange tuned frequency simultaneously. The discrepancy value is the difference in amplitude the user hears between the adjusted amplitude of the midrange reference frequency and the initial amplitude of the midrange tuned frequency played back during testing. The midrange tuned frequency may be assigned to a fader that the user can control to change the amplitude of the midrange tuned frequency in real-time to compare the amplitude of the midrange tuned frequency to that of the adjusted amplitude of the lower range reference frequency. The user adjusts the fader until the amplitude of the midrange tuned frequency matches that (i.e., is equal to) the adjusted amplitude of the lower range reference frequency.

Additionally, the modifying step may include extrapolating a modified amplitude of multiple midrange tuned frequencies from the user sound profile along a sine sweep curve based on the discrepancy value. In other embodiments, the system may also change the modified amplitudes of the multiple midrange tuned frequencies in equal increments between 1 kHz and 5 kHz, or may change the modified amplitudes of the multiple midrange tuned frequencies based on other data gathered by users submitting tuning feedback.

In another aspect of the embodiments disclosed herein, an audio tuning system includes a user-interactable interface having a baseline audio profile that includes a lower range reference frequency having an amplitude equal to an amplitude of a midrange reference frequency. A headphone in communication with the user-interactable interface is able to playback the lower range reference frequency, and at least one fader coupled with the user-interactable interface may be user-adjustable to alter an initial amplitude of a midrange tuned frequency to equal the playback amplitude of the lower range reference frequency for storage in connection with a user sound profile associated with the headphone.

In one embodiment, the user-interactable interface may be a graphical user interface accessible by way of a computer, tablet or smartphone, and the fader may be an icon movable within the graphical user interface. Alternatively, the user-interactable interface may be a mixer, and the fader may be a movable knob. In some embodiments, the graphical user interface may be an advanced graphical user interface that includes multiple faders, such as may be associated with a fader controller. Each of the one or more faders may be actuable between a first non-engaged position where no midrange tuned frequency plays back through the headphones and a second engaged position where the midrange tuned frequency plays back through the headphones. The multiple faders may be assigned a midrange frequency between 1 kHz and 5 kHz, wherein the headphones may include a switch actuable to activate one of multiple programmable user sound profiles associated therewith.

In another aspect of the embodiments disclosed herein, another process for tuning a headphone includes changing an amplitude of a lower range reference frequency to equal an amplitude of a midrange reference frequency in a baseline audio profile, generating a tone at the changed amplitude of the lower range reference frequency and a tone at an initial amplitude of a midrange tuned frequency from a user audio profile, and modifying the initial amplitude of the midrange tuned frequency in the user audio profile to equal the changed amplitude of the lower range reference frequency.

Additionally, in these embodiments, the system may tune the baseline audio profile and map a sine sweep to the baseline audio profile so that the system can more easily and automatically assign the lower range reference frequency multiple adjusted amplitudes from the sine sweep, each of which would correspond to an amplitude of one of multiple other midrange reference frequencies of the baseline audio profile. As such, here, the modifying step may include changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies. Furthermore, the system may also blend the set of discrepancy values to create a user-specific Q filter with a relatively higher resolution mapping the user sound profile to the baseline audio profile. In these embodiments, each of the multiple other midrange reference frequencies may have a frequency the same as multiple other midrange tuned frequencies, and the lower range reference frequency may be a single frequency within a range of 100 Hz to 500 Hz, while the midrange reference frequency may be a single frequency within a range of 1 kHz to 5 kHz. To tune the midrange tuned frequency, the system may play the lower range reference frequency and the midrange tuned frequency intermittently.

In another embodiment, a process for tuning a headphone may include steps that include loading a desired amplitude value for at least one audio frequency, coupling the headphone to a user so a microphone associated therewith is positioned proximate an ear canal of the user, and then playing the at least one audio frequency at the desired amplitude value with the headphone. Thereafter, the microphone may record a perceived amplitude value for the at least one audio frequency, and the system may then compare the perceived amplitude value with the desired amplitude value for the at least one audio frequency in order to alter play back of the at least one audio frequency to a modified amplitude value the microphone identifies as closer in value to the desired amplitude value than the perceived amplitude value. As such, by way of these steps, the system can produce audio through the headphones having a frequency response experienced by the individual user wearing the headphones that is more closely aligned with the frequency response intended by the manufacturer.

In another aspect of these embodiments, the system may simultaneously perform the playing, recording, comparing, and altering steps with the headphone having a pair of microphones and a pair of speakers. Here, each of the speakers may be independently associated with one of a pair of cars of the user. This way, because even the right and left ear canals of a single user can differ anatomically from one another, the left and right speakers of the headphones can be simultaneously individually tuned to produce sound that each of the left and right rears experience that is commensurate in scope with the manufacturer desired frequency response. As a result, in some embodiments, the altering step may include reproducing the at least one audio frequency at a pair of modified amplitude values that are different for each of the pair of cars of the user.

Moreover, the system may alternate between the playing step and the recording step, such as when playing a single tone. This may give the microphone a better opportunity to identify a more accurate discrepancy value between the desired amplitude and the perceived amplitude for any given frequency. In other embodiments, the system may play music from a speaker in the headphone, and alter amplitudes based on measurements taken by the microphone of those music frequencies. After identifying one or more discrepancy values for one or more frequencies, the system may generate a collective corrective output based on the modified amplitude value(s) having a transfer function with a Q value. Here, the corrective output may include a linear audio processing output or a combination of the linear audio processing output and a non-linear audio processing output.

Additionally, the at least one audio frequency may include a set of discrete frequencies or

a frequency range. Here, the number of discrete frequencies the system may tune may be between two and one thousand frequencies, or more. Alternatively, the frequency range may include a low frequency range (e.g., between 20 Hz to 800 Hz), a mid-frequency range (e.g., between 1-5 kHz), or a high-frequency range (e.g., frequencies above 6 kHz). Here, the system may include a step for selecting the frequency range based on at least 80% of the frequencies within the frequency range being within one standard deviation of the mean difference between the perceived amplitude value and the desired amplitude value of all compared frequencies between 20 Hz and 20 kHz. The altering step may include playing multiple audio frequencies at their respective modified amplitude values.

Moreover, the system may also provide an option for the user to select a frequency different than the at least one audio frequency automatically tuned by the system, and then enable the user to manually adjust the amplitude of the selected frequency with a graphical user interface. Further tuning may also be accomplished by using a reference audio frequency having a reference desired amplitude value the same as a reference perceived amplitude value produced by the headphone at the reference audio frequency. Any modifications may be saved for the at least one audio frequency. In some embodiments such modifications may be saved for a first user, and a second set of modifications may be saved for a second user, thereby effectively creating a sound profile for two persons who may wear the headphones. The users may also have an option to select a reference frequency response, and then change the desired amplitude value to new desired amplitude value(s) that correspond with the selected reference frequency response.

In another embodiment as disclosed herein, a process for tuning a headphone in real-time may include steps that include storing a set of reference amplitude values for a set of audio frequencies, positioning a microphone associated with the headphone proximate an ear of a user, playing the set of audio frequencies at the set of reference amplitude values, and adjusting playback of the reference amplitude values in real-time by a discrepancy value that can be calculated as the difference between the reference amplitude value and a perceived amplitude value measured by the microphone for each of the set of audio frequencies.

Here, the adjusting step may occur within milliseconds of the playing step and include comparing the reference amplitude value to the perceived amplitude value to create or identify the difference or discrepancy between the two values. Similar to the embodiments disclosed above, the set of audio frequencies in these embodiments may also include a discrete number of frequencies (e.g., a predetermined number of frequencies to be tuned) or a frequency range. In some embodiments, the frequency range may be between 1 kHz and 5 kHz. Furthermore, the system may also include steps of repeating the playing and adjusting steps, and then creating a respective modified amplitude value for each of the set of audio frequencies perceived by the microphone to be closer in value to the respective reference amplitude value than the perceived amplitude value.

In another embodiment, an audio tuning system disclosed herein may include a headphone (e.g., an earbud or a set of over-ear headphones) selectively attachable relative to an car canal. A speaker coupled with the headphone may be positionable relative to the ear canal to direct a set of sound waves therein, and a microphone positionable relative to the ear canal may be designed to capture and record the set of sound waves from the speaker at amplitudes comparable to that perceived by the ear canal. Here, the microphone may include an integrated sound level meter, and the headphone may be able to communicate with a remote processor by way of a wireless or wired communication circuit.

In some embodiments, the microphone may be integrated within the earbud and selectively positionable within the ear canal when the earbud is coupled to an ear. In other embodiments, the earbud has an ear-tip for forming a closed tube resonator with the user's ear canal. Here, the microphone faces an ear-tip cavity of the user's ear, and the microphone may take up a footprint of several square millimeters or less. In some embodiments, the microphone may be an ultra-miniature microphone having a footprint less than 1 square millimeter. In some embodiments, the microphone may be selectively detachable from the headphone, thereby allowing the user to selectively position the microphone relative to the ear canal. Additionally, the system may further include a graphical user interface having a communication circuit communicable with the audio tuning system and including at least one control that allows the user to adjust an amplitude of an audio frequency produced by the speaker.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagram illustrating the discrepancy in frequency response of a sine sweep played through a common headphone as experienced by two different listeners;

FIG. 2 is a flowchart illustrating a process for headphone tuning using a single midrange frequency, as disclosed herein;

FIG. 3 is a flowchart similar to FIG. 2, illustrating tuning and blending multiple midrange frequencies;

FIG. 4 illustrates a graphical user interface for tuning one midrange reference frequency with a single fader;

FIG. 5 illustrates an advanced graphical user interface in the form of an audio mixer for tuning multiple midrange frequencies with a series of faders;

FIG. 6 illustrates a graphical user interface featuring music, for testing and fine-tuning headphones to one or more music genres;

FIG. 7A illustrates an exemplary headphone in the form of an earbud, for automating the process for headphone tuning;

FIG. 7B illustrates a cutaway view of a user ear having the earbud coupled thereto and forming a closed tube resonator therein for headphone tuning;

FIG. 8 is a flowchart illustrating a process for automating the process for headphone tuning, such as by way of the earbuds illustrated in FIGS. 7A and 7B;

FIG. 9 is a flowchart illustrating a process for automatically tuning a headphone in real-time; and

FIG. 10 is a diagrammatic view of a system for automatically tuning a headphone, such as by way of the processes illustrated in FIGS. 8 and 9.

### DETAILED DESCRIPTION OF THE PREFERRED EMBODIMENTS

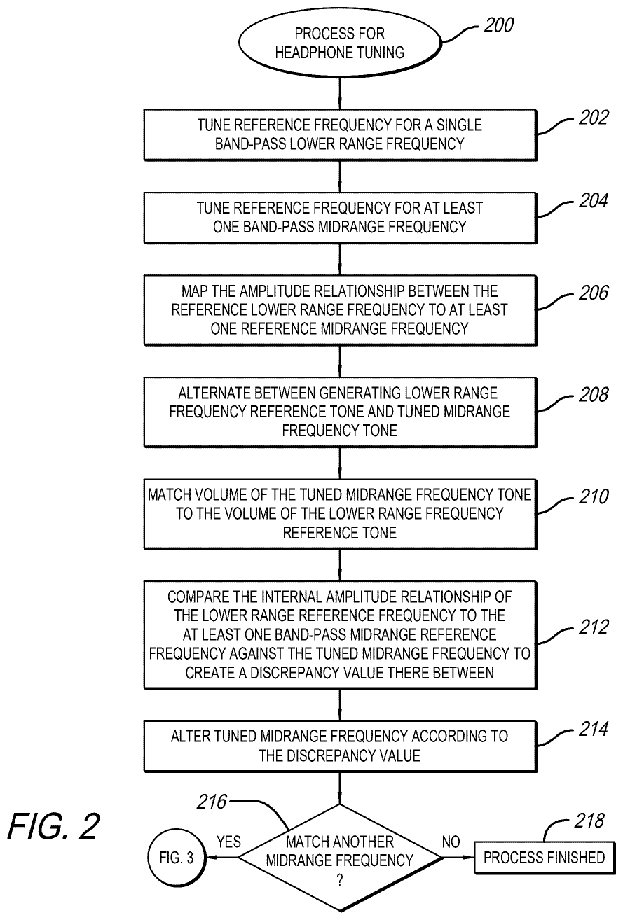

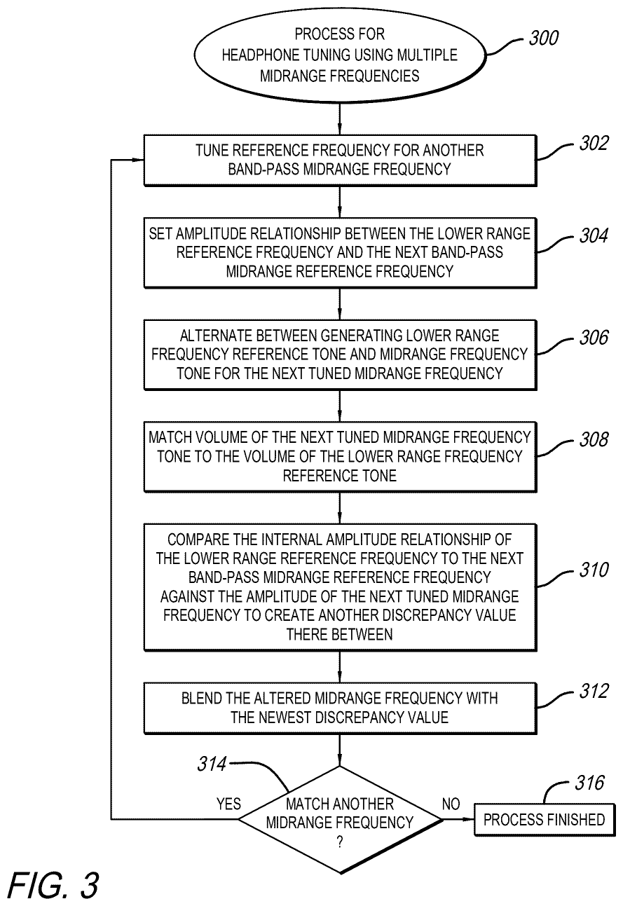

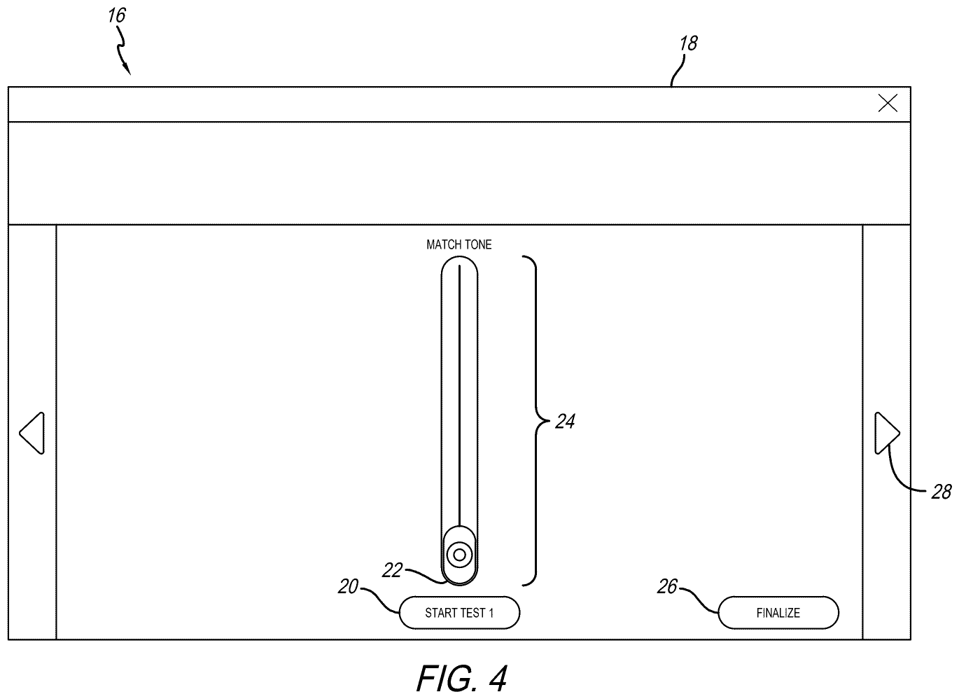

As shown in the exemplary drawings for purposes of illustration, a pair of processes (200) and (300) for headphone tuning are generally illustrated with respect to the flowcharts of FIGS. 2 and 3, and some exemplary systems for carrying out those processes (200) and (300) are illustrated with respect to reference numeral 16 in FIGS. 4-6. Generally, the processes (200) and (300) carried out by the system 16 are designed to enable an audio listener to customize the sound profile played through the speakers of a headphone based on individual, unique auditory perception. Doing so enhances the listening experience for each user as the spatial audio playback through the headphones has a binaural illusion that is more convincing and realistic because the frequency response experienced by the user is specifically tuned to how the headphone manufacturer intended the sound to be heard. Ensuring that all users have approximately the same frequency response from the same set of headphones, regardless of differences in inner ear anatomy or HRTF, enhances the auditory experience for the user of the headphones.

Generally, the system 16 is an interactive custom sound test that enables a user to calibrate headphones so the amplitude of certain frequencies within a sound profile can be more consistently experienced from user to user. The system 16 maps out differences in the amplitudes of certain midrange frequencies against the amplitudes of a baseline sound profile within certain low range frequencies (e.g., published by the manufacturer), and then alters the differing amplitudes the user actually experiences in the tuned midrange frequencies based on feedback from the user during testing/tuning. Modifying the sound profile of audio input played back through the headphones by adjusting the amplitude of midrange frequencies to reduce discrepancies a listener experiences relative to a baseline sound profile published by the manufacturer helps create a more consistent audio experience for the user by accounting for differences in user ear anatomy and HRTF. As such, the system 16 and the related processes (200) and (300) disclosed herein are designed to facilitate tuning the headphones to a desired frequency response that better matches that of the intended amplitudes the manufacturer wants the user to experience when listening to audio.

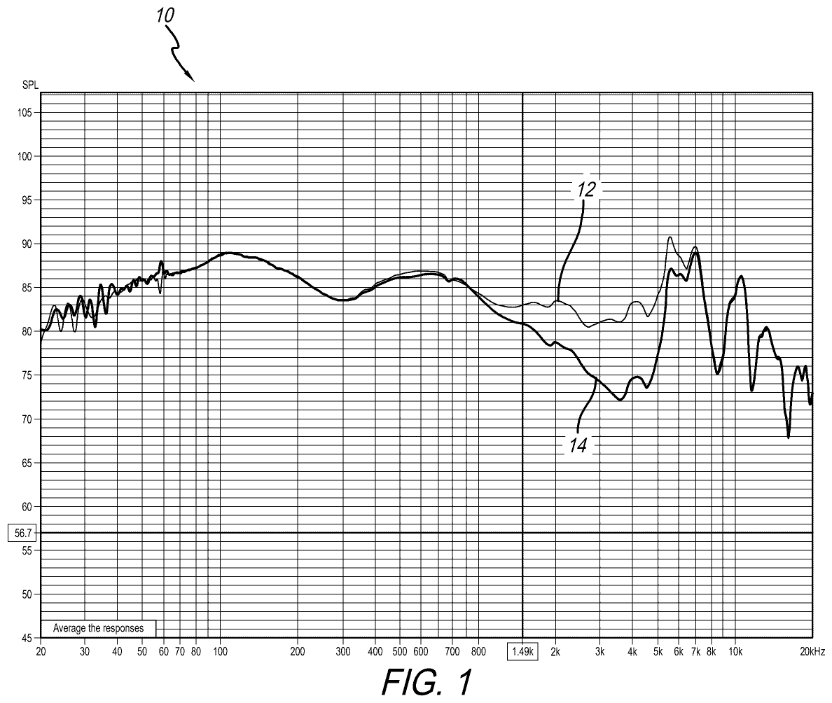

The process (200) starts by tuning a reference frequency for a single band-pass lower range frequency as part of a step (202). The system 16 can consistently map the amplitudes for reference tones within lower frequency ranges because they tend to be common among all users/listeners regardless of differences in anatomy or HRTF. This is illustrated, e.g., in FIG. 1 with respect to fact that the frequency response for the first listener mapped as the first sine sweep 12 overlaps with the frequency response for the second listener mapped as the second sine sweep 14 within frequency ranges below about 800 Hz, even though the first and second listeners have different inner ear anatomies and/or other HRTF considerations. In fact, FIG. 1 is representative of the fact that the average response to sound frequencies between 100 Hz and 500 Hz is almost exactly the same for all users, regardless of the fact that each user may have a different ear anatomy and HRTF. Because all users or listeners tend to perceive sound in headphones at similar amplitudes within the lower frequency range of 100 Hz to 500 Hz, the filter shape within this lower frequency range, e.g., as illustrated in FIG. 1, is typically consistent for all users.

As such, one or more lower range reference frequencies produced by the headphone within this filter shape can be tuned to a specific amplitude and used as one or more baseline reference point(s) for determining adjustments to the input audio within midrange frequencies, where users typically experience differences in frequency amplitudes, as discussed in more detail below. While one reference point is needed for this comparison, using multiple reference points as additional baseline reference points may provide more datapoints to more accurately adjust the amplitude of midrange frequencies during the tuning processes (200) and (300) disclosed herein, as may be uniquely experienced by each individual user.

Once at least one reference frequency for a single band-pass lower range frequency has been tuned and selected as part of step (202), the next step (204) is for the system 16 to tune a reference frequency for at least one band-pass midrange frequency, which is typically considered to be in the range of 1 kHz to 5 kHz where the deviation in amplitude tends to vary the most from one listener to another, as briefly mentioned above. Mapping at least one of these midrange frequencies is used by the system 16 as a metric to determine variations in amplitudes on a listener-by-listener basis to develop a discrepancy value that can be extrapolated within the midrange frequencies to make adjustments to the input audio so that the frequency response experienced by the user better matches a baseline sound profile recommended by the manufacturer. This relationship can be accomplished in step (206) by mapping out the sine sweep of a baseline sound profile, and then correlating the reference frequency from the lower range with a reference frequency somewhere in the midrange.

In using the sine sweep 12 in FIG. 1 as an example of a sine sweep of a baseline sound profile (e.g., recommended by a manufacturer), the amplitude of the 100 Hz frequency is approximately 89 db while the amplitude the user should hear (e.g., as may be recommended by the manufacturer for peak performance) at the 1.49 kHz midrange frequency should be approximately 83 db. As such, the system 16 can map the amplitude of the 100 Hz frequency to 83 db so it matches the amplitude of the frequency the user is expected to hear at 1.49 kHz. In other words, the volume of the 100 Hz frequency can be adjusted to 83 db so it matches the volume of the frequency the user should perceive at 1.49 kHz. Users will consistently hear the 100 Hz frequency tone at 83 db regardless of ear anatomy.

For the purposes of process (200), it is only necessary for the system 16 to select one lower range frequency (e.g., in this example, the amplitude at 100 Hz) and one midrange frequency (e.g., 1.49 kHz) for comparison purposes, but multiple midrange frequencies could be selected for comparison to the lower range reference frequency to achieve a higher matching resolution of the sound profile alterations, as will be discussed in detail herein. In other words, tuning the lower range reference frequency to more midrange frequencies will help the system 16 better match the actual frequency response experienced by the user to the frequency response recommended by the manufacturer because the amplitude discrepancies the user experiences within the selected midrange frequency range (e.g., 1 kHz to 5 kHz) is not necessarily linear, e.g., as illustrated in FIG. 1. In an example where the first sine sweep is the baseline frequency response recommended by the manufacturer, the system 16 will ideally make incremental adjustments to the amplitudes illustrated with respect to the second sine sweep 14 so the practical frequency response experienced by the user/listener actually matches the first sine sweep 12. So, the more frequencies within the midrange that are mapped and tuned, the higher the resolution of adjusting the input audio represented by the second sine sweep 14 to track the first sine sweep 12.

Once the initial mapping of the baseline sound profile is accomplished in step (206), the user is ready to interact with the system 16. In this respect, FIG. 4 illustrates one embodiment of the system 16 in the form of a user-interactable graphical user interface 18, such as a classic audio mixer, which may be accessed by way of a tablet, smartphone, desktop or laptop computer, or other comparable electronic devices known in the art, which may connect to the system 16 by a wireline connection or wirelessly, or otherwise sync with the headphones in a manner capable of transmitting audio therewith. Of course, the user-interactable graphical user interface 18 could also be in the form of a traditional mixer having physical audio controls. In any of these embodiments, the user is able to interact with the graphical user interface 18 to activate the tone of the reference frequency in the lower frequency range at an amplitude (i.e., decibel level) desired at the tuned midrange frequency.

In application, in one embodiment, the system 16 may alternate between playing a tone of the lower range reference frequency having an amplitude adjusted to match that of the amplitude of the recommended midrange frequency being tuned, and the actual midrange frequency being tuned. Doing so enables the user/listener to hear differences in the volume (amplitude) of the two isolated tones as they alternate during playback. This enables the user/listener to then match the amplitude of the selected midrange frequency to that of the tone of the lower range reference frequency as part of a step (210). Alternatively, the system 16 may playback the tuned midrange frequency in the inner ear as a constant tone, while pulsing tones of the lower range reference frequency, and vice versa, to facilitate amplitude matching.

More specifically as illustrated in FIG. 4, this alternating step (208) may be initiated by selecting a start test button 20 within the graphical user interface 18. This may activate transmission of the tone of the lower range reference frequency and the tone of the midrange frequency to be tuned to the speakers in the headphones, in accordance with the embodiments disclosed herein. For example, quickly pulsing the selected lower range reference frequency during tuning may help excite the auditory system of the user in a way that makes the amplitude of the signal easier to perceive when compared to the midrange frequency being tuned.

Thereafter, the step (210) of matching the volume of the tone of the midrange frequency to the volume of the tone of the lower range reference frequency is facilitated by selecting and holding a volume slider or fader 22, which is designed to change the amplitude of the tone of the selected midrange frequency being tuned in the headphones. Here, the fader 22 can move vertically along a slider 24 to alter the volume or amplitude of the tone of the midrange frequency. In this embodiment, moving the fader 22 upwardly along the slider 24 increases the amplitude of the frequency within the headphones (i.e., increases the volume of the midrange frequency tone), while moving the fader 22 downwardly along the slider 24 decreases the amplitude of the frequency (i.e., decreases the volume of the midrange frequency tone). Although, the amplitude can be adjusted using other digital or physical knobs or faders as known in the art. When the user stops moving the fader 22, and while still depressing the fader 22, the midrange frequency reference tone plays through the headphones. The midrange frequency reference tone may automatically alternate with the lower range reference frequency, or the user may need to manually alternate between the two frequencies by tapping the fader 22.

As such, the user is able to hear both the tone of the lower range reference frequency and the tone of the midrange frequency in alternating sequence for purposes of adjusting the fader 22 along the slider 24 to eventually arrive at a condition where the amplitude of the tone of the midrange frequency matches the amplitude of the tone of the lower range reference frequency. In the example mentioned above, the user would move the fader 22 along the slider 24 until the amplitude of the frequency response of the midrange frequency being tuned is perceived by the user tuning the system 16 to be approximately equal to that of the amplitude of the lower range reference frequency altered to tune the midrange frequency (e.g., 83 db in the example mentioned above). Once the user determines that the amplitude of the tone of the midrange frequency matches that of the amplitude of the tone of the lower range reference frequency according to the volumes heard by the user through the headphones, the user releases the slider 22 to lock the value in place.

In another embodiment, the tone of the lower range reference frequency may pulse at predetermined intervals when the fader 22 is not actively selected by the user, and turn off when the fader 22 is actively selected by the user. In this embodiment, because the frequency zones between the tone of the lower range reference frequency and the tone of the midrange frequency being tuned are spectrally distant, pulsing constant playback can make it easier for the user to match the amplitude of the tone of the lower range reference frequency to that of the amplitude of the tone of the midrange frequency being tuned. This may enable the user to more quickly match the perceived amplitude of the midrange frequency playing in the headphones to that of the amplitude of the tone of the lower range reference frequency for purposes of completing the matching step (210).

Once the match has been identified by the user in step (210), and the fader 22 has been released, the system 16 processes the differences in amplitudes to create a discrepancy value therebetween as part of a step (212). Here, the discrepancy value is calculated by taking the difference of the internal amplitude relationship of the lower range reference frequency to the at least one band-pass midrange frequency against the tested midrange frequency.

In the example mentioned above, the system 16 determined that the internal amplitude relationship of the lower range reference frequency to the at least one band-pass midrange frequency was 83 db. The discrepancy value is thus the difference between the amplitude of the first sine sweep 12 (i.e., manufacturer recommended amplitude of 83 db, which should be heard by the user at 1.49 kHz) and the second sine sweep 14 (i.e., the amplitude of 81 db actually perceived by the user tuning the headphones at 1.49 kHz). Here, the difference between the desired 83 db amplitude and the 81 db amplitude perceived by the frequency response of the user is 2 db. While the discrepancy value in this example is 2 db, the discrepancy value could be upwards of ±10 db, or more, depending on the manufacturer recommended values and anatomy of the user.

This discrepancy value is then used by an equalizer processor as part of a step (214) to alter the midrange frequency along the sine sweep curve to better replicate the intended sound within the headphones for that particular user or listener sound profile. In one embodiment, the alteration may be based on a single value through a predetermined frequency range (e.g., 1 kHz to 5 kHz). In the example mentioned above where the discrepancy value of the midrange frequency being tuned is 2 db, this would include altering the amplitude for all frequencies between 1 kHz and 5 kHz upward by 2 db using a custom Q filter. Doing so draws the frequency response embodied by the second sine sweep 14 into closer approximation with the first sine sweep 12 intended for the user listening experience. As such, once the equalizer process finishes, the headphones will have a unique filter preset customized for a particular user, which is designed to produce a frequency response unique for that user so the audio perception better matches the audio perception recommended by manufacturer.

Alternatively, the equalizer processor may not alter the midrange frequency along the sine sweep curve linearly. In this respect, the equalizer processor may determine that the discrepancy value needs to vary depending on the midrange frequency. For example, the equalizer processor may change the amplitude for certain frequencies by more or less decibels than the discrepancy value. For example, if the discrepancy value between the first sine sweep 12 and the second sine sweep 14 is approximately 10 db at 3.5 kHz, the equalizer processor may progressively decrease the discrepancy value from 3.5 kHz to 1 kHz and from 3.5 kHz to 6 KHz. The equalizer processor may automatically make these changes based on average discrepancies from user feedback or other known preconditions. Such changes may be linear progressions between certain frequency iterations, or the changes in the discrepancy value from one frequency to another may be based on other data, such as average or mean alterations for feedback data collected from users over time. Again, the goal here is to modify the second sine sweep 14 so it maps as closely as possible to the first sine sweep 12.

For example, with respect to FIG. 1, such extrapolation may include increasing the amplitudes for certain frequencies for the second user defining the second sine sweep 14 by between 1 db (e.g., in the range of about 1 kHz to 1.5 kHz) and 8 db (e.g., in the range of about 3 kHz and 5 kHz). Alternatively, if the reference frequency is represented in FIG. 1 by the second sine sweep 14, then the system 16 would adjust the audio output by decreasing certain frequencies defined by the first sine sweep 12 by between 1 db (e.g., in the range of about 1 kHz to 1.5 kHz) and 8 db (e.g., in the range of about 3 kHz and 5 kHz) to better match the first sine sweep 12 to the second sine sweep 14. In this respect, the equalizer processor in the system 16 uses the discrepancy value to change the speaker output in the headphones so the user hears audio more consistent with the maximum intended amplitude for certain frequencies recommended by the manufacturer.

Once the user successfully matches the frequencies and the equalizer process concludes, the user must then determine whether to match another midrange frequency as part of step (216), if the option is provided. For basic users, the option may not be provided because the process (200) may suffice so the user can match one midrange frequency tone to the single lower range reference frequency. As such, if the user determines that there is no need to match an additional midrange frequency, or is not given the option in the graphical user interface 18, the user may select a finalize button 26 (FIG. 4) and the process finishes as part of step (218). At this point, the system 16 has programmed a unique filter preset (e.g., a relatively wide Q curve with a center point, e.g., of around 3.5 kHz when this frequency is selected as the midrange frequency to tune) for the headphones customized to the user who provided feedback data from the test as part of the process (200). The filter preset uses specifically tuned filters at the midrange frequencies and the preset filter shape is different than the test frequency filter shapes. This new filter preset customizes the audio spectrum for each ear so the audio perception for that specific user now more closely matches the audio perception as intended by the manufacturer.

In one embodiment, the headphones may be programmable to be used with multiple users. As such, more than one user could complete the process (200) and/or the process (300) discussed in more detail below, and save their unique tuning data in connection with a profile associated with the headphones. The headphones may include a selector (e.g., a switch or button) that allows a user to select their profile so the headphones apply that user's filter preset previously tuned for use with the headphones. The profile may also be controlled with a software application, such as an app on a smartphone.

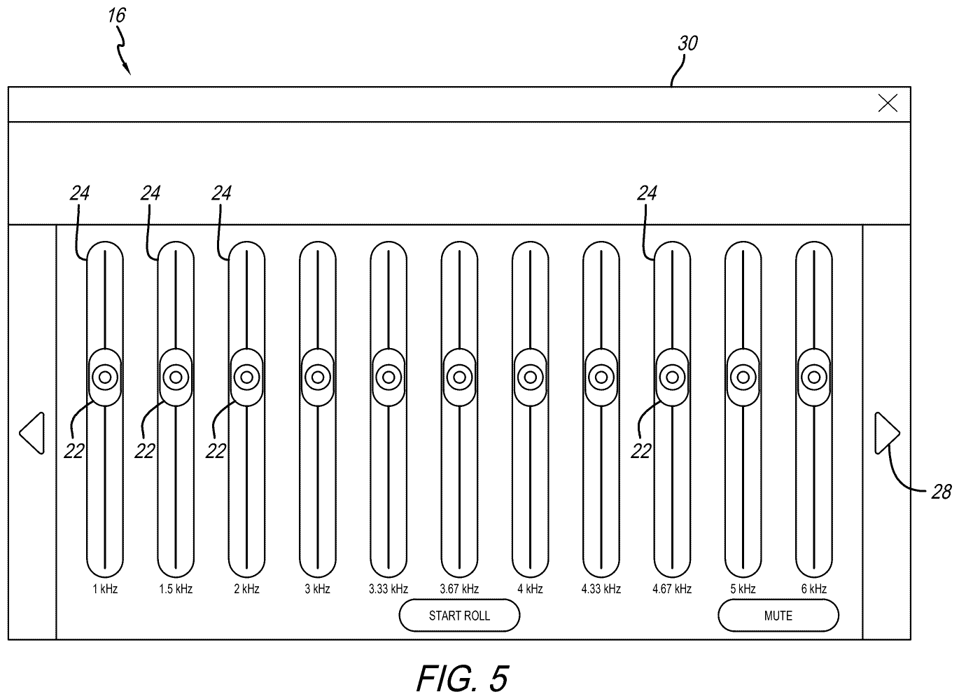

Alternatively, the user may decide as part of step (216), when given the option, to match additional midrange frequencies and move to a more advanced process (300), which would enhance the resolution and accuracy related to tuning the filter preset for each particular user within the midrange frequencies. In one example, more advanced audio listeners may have the option to tune three midrange frequencies. Here, the resulting equalizer processor may compile a preset filter that contains three filters using a slimmer Q curve. This provides a more detailed result because the tuning is now based on three unique frequency zones, e.g., within the 1.5 to 5 kHz range. In another example, advanced audio listeners may have the option to tune up to eleven midrange frequency tones. This provides an extremely customized listening experience for the user because the system 16 tunes fine portions of the midrange frequency response. In this embodiment, as illustrated below with respect to one example in FIG. 5, the resulting equalizer curve may have many relatively thin frequency zones, e.g., in the 1.5 kHz to 5 kHz range.

As such, in general, providing further data points to alter the midrange frequencies helps the system 16 better match the expected user experience intended by the manufacturer. For example, as illustrated in FIG. 4, the user may start the process (300) by selecting a next or forward button 28. The user may next have the option of manually selecting one or more additional frequencies to tune as part of the process (300). In this embodiment, the user may be able to select additional frequencies one-by-one to tune the headphones on a frequency-by-frequency basis. Accordingly, after selecting another band-pass midrange frequency to tune as part of step (302), the system 16 next sets the amplitude relationship between the prior selected lower range reference frequency and the next band-pass midrange frequency as part of step (304), similar to that disclosed above with respect to step (206).

Here, the user may again be presented with the graphical user interface 18, except this time the fader 22 changes the amplitude of the next band-pass midrange frequency being tested. Similar to the embodiments discussed above with respect to step (208), the system 16 may alternate between generating the lower range reference frequency tone and the midrange frequency tone for the next midrange frequency as part of a step (306). This enables the user to hear the differences between the tone of the lower range reference frequency and the tone of the currently selected midrange frequency, and the user can move the fader 22 along the slider 24 to change the amplitude of the testing midrange frequency to match the lower range reference frequency tone as part of a step (308), in a similar manner as disclosed above with respect to step (210). The next step (310) is for the system 16 to compare the internal amplitude relationship of the lower range reference frequency to the next band-pass midrange frequency against the amplitude of the tested next midrange frequency to create another discrepancy value therebetween. Doing so creates another data point the system 16 can use to further alter the sine sweep to better match the frequency response of the intended user experience of the headphones. In this respect, the system 16 blends the previously altered midrange frequency performed as part of step (214) with the new midrange frequency discrepancy value for the next tested midrange frequency, to create a more accurate sine sweep designed to replicate the user audio experience intended by the headphone manufacturer, as part of a step (312). The equalizer processor may perform similar steps with respect to step (312) as disclosed above with respect to step (214), albeit the equalizer processor can rely on more accurate field-compiled datapoints unique to a particular user, as opposed to compiled data or algorithms that may not track the specific user's frequency response as specifically.

Next, the user may, again, be presented with an option for deciding whether to match another midrange frequency as part of a step (314) or finish the process as part of step (316). If the user decides to match another midrange frequency, the process (300) effectively starts again in step (302) by selecting another band-pass midrange frequency to tune, and then repeating steps (304) to (310) based on that next selected midrange frequency. This time, the blending step (312) would be performed using three discrepancy values once step (310) has been completed again. Using a higher resolution of datapoints enables the equalizer processor to create a more accurate alteration of the input audio to match manufacturer specifications. The process (300) continues to repeat to create new (additional) data points for blending in step (312) to create a sine sweep that more closely represents the auditory experience intended by the headphone manufacturer, and based specifically on the anatomy of the specific individual user conducting the tuning. The user may finish the process in a step (316) by selecting the finalize button 26 illustrated in FIG. 4 when finished.

Alternatively, in a more advanced mode, the system 16 may present the user with an advanced graphical user interface 30, such as the one illustrated in FIG. 5. Here, as shown, the advanced graphical user interface 30 may include multiple of the faders 22, each of which correspond to a different midrange frequency the user is able to tune. For instance, FIG. 5 illustrates that the advanced graphical user interface 30 includes eleven of the faders 22. In this respect, each of the faders 22 may represent a single midrange frequency somewhere in the range of 1-5 kHz. Although, of course, the number of the faders 22 shown in the advanced graphical user interface 30 may be as few as two, or as many as the advanced graphical user interface 30 can reasonably display (e.g., traditional large mixers can have over one hundred faders). In this respect, the frequencies assigned to each of the faders 22 may be spaced apart evenly within the 1-5 kHz range (e.g., at 1.00 kHz, 1.33 kHz, 1.67 kHz, 2.00 kHz, etc.), or the frequencies assigned to each of the faders 22 may be intermittent based on an estimate where the largest discrepancies exist between the perceived frequency response of the user and the ideal sine sweep intended by the manufacturer for any particular set of headphones. For example, in using FIG. 1 as an example, the user may be given an option to tune more frequencies within the range of about 3 kHz to 5 kHz, as these are the frequency ranges with the largest discrepancy values. Although, not all of the faders 22 may be programmed within this range. Rather, the faders 22 may programmed at 1 KHz, 1.5 kHz, 2 kHz, 3 kHz, and then spaced apart at shorter intervals between 3 kHz and 5 kHz, such as at 3.33 kHz, 3.67 kHz, 4 kHz, 4.33 kHz, 4.67 kHz, and 5 kHz, and then the last fader 22 may be programmed to tune frequencies at 6 kHz. Here, the user may be able to more specifically tune a finer range of midrange frequencies within a range having larger discrepancies, and tune fewer frequency ranges where the discrepancies are anticipated to be smaller.

Although, to the extent the system 68 is not taking enough datapoints to completely replicate the second sine sweep 14, the system 68 can extrapolate amplitude values between each frequency datapoint to create as accurate of a user experienced sine sweep as possible. Here, the relation in and among the various frequencies being tuned may be curved, linear, and/or non-smooth linear.

The system 16 may automatically assign the frequencies needing tuning to each of the faders 22, the user may manually assign the frequencies needing tuning to each of the faders 22, or the system 16 and the advanced graphical user interface 30 may be designed to automatically assign some frequencies while allowing the user to manually assign others. In the latter embodiment, the advanced graphical user interface 30 may present the user with one or more preset frequencies that can be tuned, along with an option where the user may select one or more custom frequencies to tune to be assigned the faders 22. This feature allows for more customization, especially for advanced users and audiophiles, including that the system 16 may enable the user to select the number of faders 22 to be used for tuning. This embodiment is particularly customizable when the advanced graphical user interface 30 is electronically displayed on a screen, such as a touch-sensitive tablet or smartphone.

The blending step (312), of course, takes into consideration each of the tuned frequencies and their corresponding discrepancy values after the user completes tuning using the multiple faders 22 illustrated in FIG. 5. In this embodiment, the blending step (312) may occur simultaneously for all tuned frequencies illustrated, e.g., in FIG. 5. Using multiple of the faders 22 better enhances calibration of the sine sweep because it generates more data points for the equalizer processor to use in altering the sine sweep to better match that of the one published by the manufacturer for any particular set of headphones.

To perform the matching step (308) for the embodiment illustrated in FIG. 5, the user may simply select and hold any one of the faders 22 for tuning to activate producing the lower range reference frequency at the target amplitude (volume) in alternating sequence with producing the applicable midrange frequency being tuned. In other words, selecting and holding any one of the faders 22 will isolate playback to that particular band-passed midrange frequency for tuning. Moving the fader 22 along the applicable slider 24 changes the amplitude (volume) of the applicable midrange frequency being tuned. Once the user determines that the amplitudes are comparable, e.g., as part of step (308), the user releases the fader 22 to lock the discrepancy value in place for processing. Of course, the discrepancy values for each midrange frequency assigned per each of the faders 22 may be different. The equalizer processor will then blend the altered midrange frequency based on the discrepancy values saved for each midrange frequency tuned, e.g., by the user selecting the forward button 28 illustrated in FIG. 5.

In one feature of these embodiments, the amplitude relationship of the reference frequency tone to that of the selected midrange frequency tone may be initially smart tuned to estimate the desired frequency response the manufacturer intends the user to experience. After tuning the various amplitude relationships of the tuned frequencies, all users, regardless of their personal HRTF, should experience substantially similar, and ideally the same, audio playback when listening to audio from the headphones.

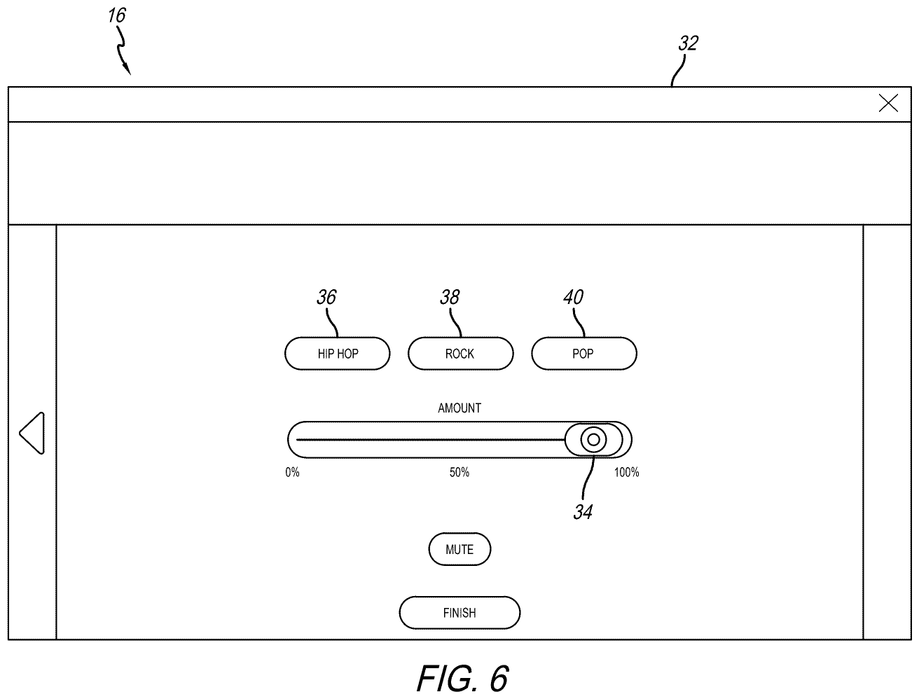

In another example, FIG. 6 illustrates an embodiment wherein the system 16 is in the form of a graphical user interface featuring music 32 where the user can listen to musical examples using the new equalizer preset (based on the values from the aforementioned tuning), to further fine tune the overall amplitude of the values using a percentage slider 34. Here, the user may select from pre-set music genres such as from a hip-hop button 36, a rock button 38, and/or a pop button 40. Although, of course, the graphical user interface featuring the music 32 may include more for less of the buttons 36, 38, 40 and/or may include other genres, like country, classical, or oldies music for testing purposes. Here, locating the slider 34 at 100% tracks the value of the tuned sine sweep exactly, while moving the slider 34 to an amount below 100% decreases the overall amplitude (volume).

There are also several options to customize the user experience. For example, users can select the pulse speed of the reference tones (e.g., the lower range reference frequency tone and/or the midrange frequency being tuned), the overall output volume, and can use both mouse and keyboard simultaneously to solo the midrange frequencies and instantly change fader values to control amplitude. A user can also perform the processes (200) and/or (300) discretely on each ear, since it is common that a user will have different spectral discrepancies (e.g., due to differences in inner ear anatomy and different HRTF) for each ear.

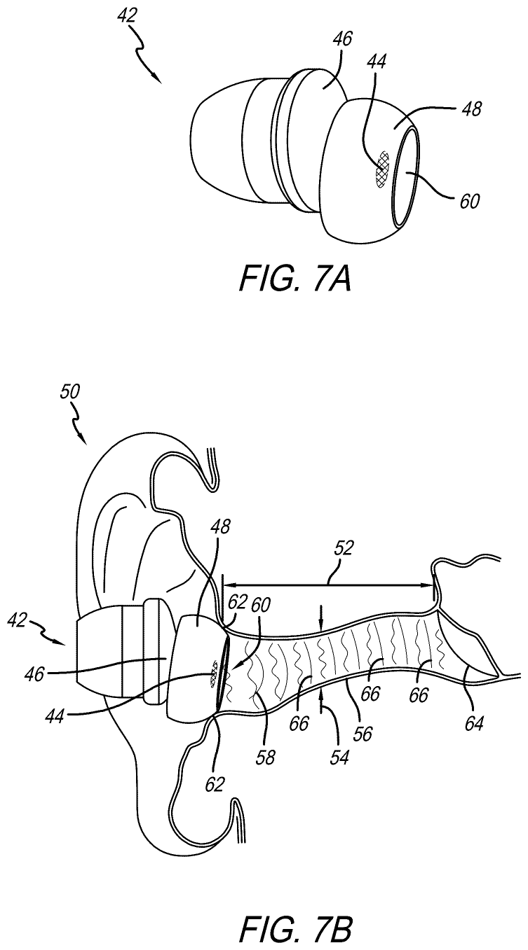

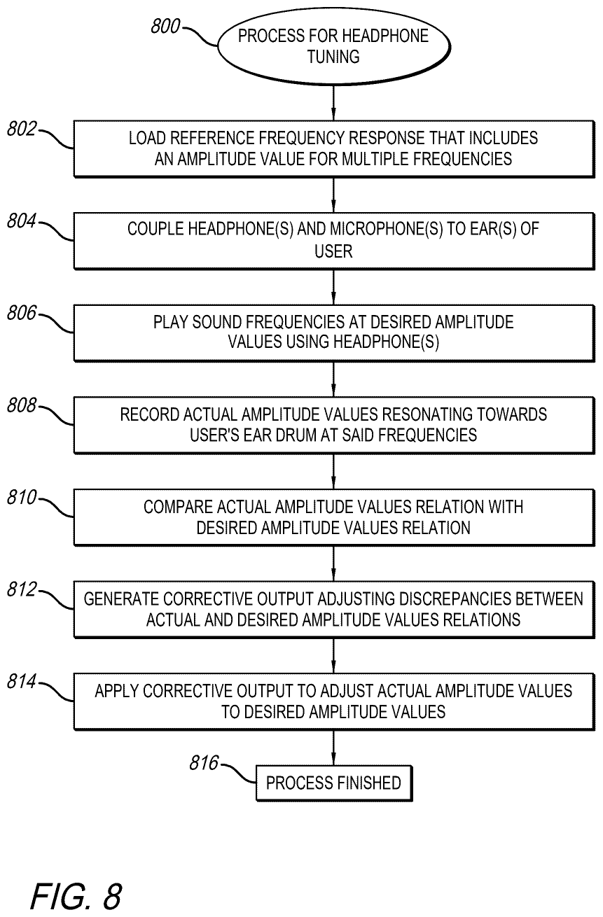

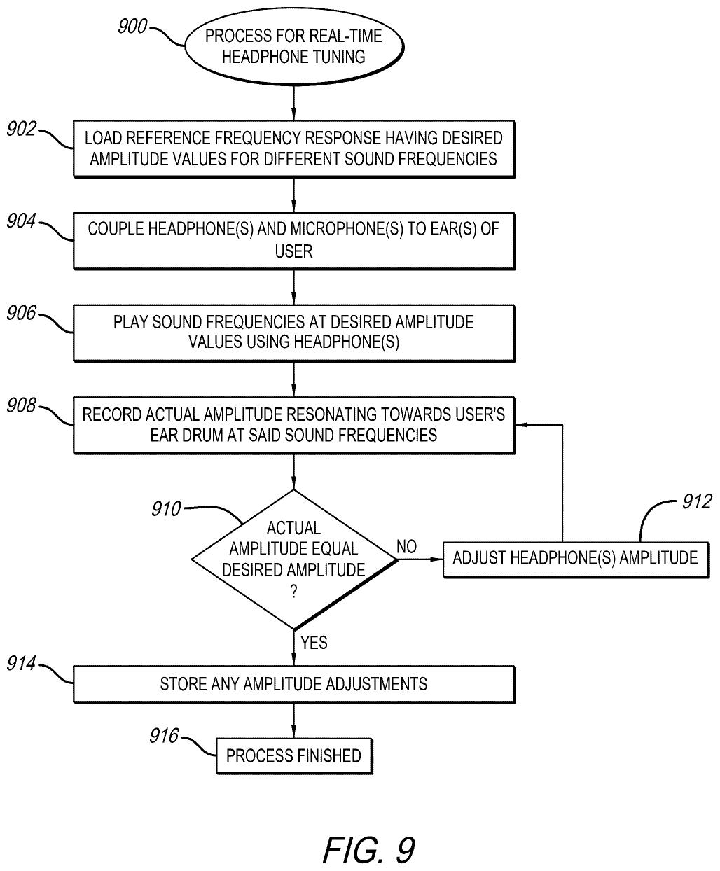

In an alternative embodiment, FIG. 7A illustrates a headphone in the form of an earbud 42 (which may be manufactured and sold as a pair for purposes of tuning two cars simultaneously) having a microphone 44 and a speaker 46 generally positioned to an interior of an outer circumferential ear-tip 48 (e.g., made of rubber or the like) thereof. Such combination of devices may be used to automatically tune the earbud 42 as part of a pair of processes (800) and/or (900) illustrated with respect to FIGS. 8 and 9, respectively. Here, instead of using the fader 22 on the graphical user interface 18 (e.g., as illustrated in FIG. 4) to manually adjust the amplitudes of certain frequencies (e.g., one or more of the midrange frequencies discussed above) to attain an optimal and/or desired sound profile prescribed by the manufacturer of the earbud 42, the ultra-miniature microphone 44 within the ear-tip 48 may work in conjunction with the speaker 46 to automatically create the modified sound profile for the user wearing the earbud 42. Here, the modified sound profile would, again, be specific to the anatomy of an ear 50 (FIG. 7B) of a user wearing the earbud 42 because a length 52 and a variable diameter 54 of an ear canal 56 along the length 52 of the ear canal 56 varies from person-to-person, and from ear-to-ear, like a fingerprint. As such, the unique construction of each ear canal 56 along the length 52, and further defined by the variable diameter 54 there along, impacts the sound profile experienced by the user wearing the earbud 42. The modified sound profile may also be adjusted to other ear anatomy features, such as the curvature of the ear canal along its length, the presence of earwax within the ear canal, and even the temperature of the ear canal. To this end, the earbud 42 coupled to the ear 50, e.g., as illustrated in FIG. 7B, is able to automatically adjust the amplitude of certain frequencies to attain the desired frequency response, e.g., without the need for manual intervention. As such, the processes (800) and/or (900) may generate a more accurate sound profile more quickly for each individual wearer of the earbud 42 based on the anatomy of the ear 50 in which the earbud 42 is being worn at the time of calibration. While FIGS. 7A and 7B show the usage of the earbud 42, other types of headphones (e.g., over-ear, on-ear, in-ear, etc.) or earbuds may also be used in connection with the processes (800) and/or (900) disclosed herein.

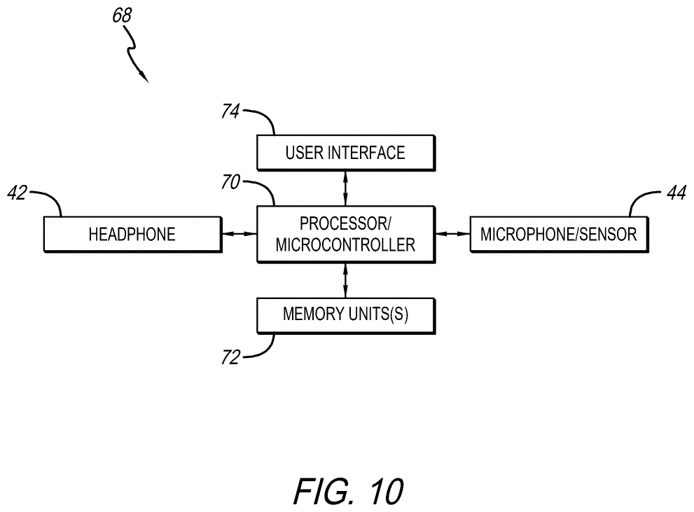

In general, and similar to the above, after establishing the optimal amplitude values of one or more audio frequencies (e.g., including within the midrange frequencies), sounds are played back through the speaker 46 within the earbud 42 for purposes of tuning the earbud 42 to match the desired frequency amplitudes (e.g., published by the manufacturer of the earbud 42). As shown in FIG. 7B, during playback, the speaker 46 generates a set of desired sound waves 58, for projection through an ear-tip cavity 60 into the ear canal 56. The ear-tip 48 of the earbud 42 helps form a seal 62 around one end of the ear canal 56 and cooperates with an eardrum 64 on the other end to effectively form a closed tube resonator in between (i.e., a semi or fully air-tight chamber within the ear canal 56). The desired sound waves 58 resonate within the ear canal 56 and are modified therein along the length 52 and by way of changes in the variable diameter 54 of the ear canal 56, for eventual travel back to the microphone 44 as a set of modified sound waves 66. The ultra-miniature microphone 44 facing the ear canal 56 through the ear-tip cavity 60 records the amplitudes of the modified sound waves 66 that the user would otherwise experience at the eardrum 64. A tuning system 68 (FIG. 10) is then able to compare the amplitudes of the desired sound waves 58 to those of the modified sound waves 66 processed by the microphone 44 for purposes of identifying one or more discrepancy values therebetween.

As such, the system 68 may selectively adjust one or more amplitudes for one or more frequencies that the system 68 determines do not match the optimal or reference amplitudes published by the manufacturer. This, in effect, generates a corrective output (e.g., a transfer function with a Q value) having effectively adjusted the actual amplitudes to be closer to, and ideally the same as, the desired reference amplitudes published by the manufacturer. In some embodiments, this automated process can be done in real-time because the microphone 44 is able to record the amplitudes of multiple frequencies simultaneously, which can then be processed concurrently to auto correct any discrepancies between the actual amplitude(s) recorded by the microphone 44 and the optimal or desired amplitude(s) the listener should be experiencing, all in real-time.

In one embodiment, FIG. 8 illustrates a process for tuning a headphone (800) utilizing the earbud 42 illustrated in FIGS. 7A and 7B. One aspect of listening to music with the earbud 42 is that the anatomy of each ear 50, e.g., the length 52 and/or the diameter 54 of the ear canal 56, tends to alter the amplitude of the desired sound waves 58 produced by the speaker 46 to those of the modified sound waves 66 at certain frequencies. As a result, music or other sounds played back with the earbud 42 do not necessarily fall within the desired amplitudes based on default tuning of the earbud 42 by the manufacturer. The process (800), as discussed in more detail below, is designed to modify the sound profile experienced by the user to match that of the desired frequency response intended by the manufacturer of the earbud 42. As such, for the user to hear the intended frequency response designed by the manufacturer, the earbud 42 may be designed to process changes to amplitudes for one or more frequencies across a spectrum of audible frequencies.

The first step (802) in the process (800) involves loading a reference frequency response having desired amplitude values for multiple frequencies, such as may be published by the manufacturer of the earbud 42. In this respect, the determination of the desired audio amplitude for each selected frequency may be based on the amplitude values the manufacturer of the earbud 42 believes are optimal for the listener, and may be provided in the specifications of the earbud 42. Of course, the desired amplitude values for certain frequencies may vary by manufacturer and the design of certain headphones, even different versions of headphones made by the same manufacturer. In other embodiments, the amplitude for each reference frequency may be programmable such as by way of software or firmware, including over-the-air or by way of the internet. Here, the manufacturer could provide different reference frequency response files that could be loaded, stored, and tuned in connection with certain headphones, depending on the desired frequency response the manufacturer of the headphones wants the listener to experience. For example, the reference frequency response may vary depending on the audio effects the listener is to experience. In these embodiments, the user may be able to select from one or more sound profiles designed to tune the earbud 42 to provide a particular frequency response experience.

In one embodiment, the earbud 42 may communicate with or otherwise include the integrated tuning system 68, which may include, e.g., a processor or comparable microcontroller 70 designed to interface with sound being recorded by the microphone 44 of the earbud 42. Here, in addition to processing sound picked up by the microphone 44, the microcontroller 70 may also interface with one or more memory units 72, e.g., where the reference and/or desired sound profile may be stored. The microcontroller 70 may then lookup certain reference frequency response profiles for processing in connection with the amplitudes of certain frequencies measured by the microphone 44 within the earbud 42, e.g., as part of step (802). The tuning system 68 may store a discrete number of audio frequencies or a range of frequency values for which the perceived audio frequency amplitudes recorded by the microphone 44 within the earbud 42 are compared against (e.g., as part of step (810), discussed in more detail below). This enables the system 68 to adjust the perceived audio frequency amplitudes to better match those of the desired reference frequency amplitudes recommended by the manufacturer of the earbud 42. The relation between the desired amplitudes at different audio frequencies may be linear, curved, or non-smooth linear, e.g., when plotted on a graph, similar to FIG. 1. In some embodiments, such relation may be compiled by the microcontroller 70 and stored in the memory unit 72 of the tuning system 68.

More specifically, e.g., if the first sine sweep 12 illustrated in FIG. 1 embodies the desired amplitudes at certain frequencies, all or a portion (e.g., midrange frequencies in the 1 KHz-5 kHz range) of these amplitudes may be loaded and/or stored by the tuning system 68 for the tuning process (800) as part of the initial step (802). Storing the entire sine sweep 12, e.g., may provide more thorough tuning because the tuning system 68 has more datapoints to adjust across the entire audio spectrum. Here, the tuning system 68 may be able to adjust the perceived sine sweep 14 at more discrete iterations to more closely and accurately adjust the perceived sine sweep 14 experienced by the listener to match that of the reference sine sweep 12, as disclosed herein.

Although, of course, the tuning system 68 may store less than the entire sine sweep 12 (e.g., certain amplitudes for between 1 and 1,000 frequencies), including, e.g., one or more reference points below 1 kHz and/or above 5 kHz, along with a set of datapoints within the midrange frequencies in the 1-5 kHz range. Although, of course, in other embodiments, more than 1,000 discrete frequencies may be loaded as part of step (802). In one embodiment, the tuning system 68 may select a frequency range where at least 80% of the frequencies within the frequency range are within one standard deviation of the mean difference between the actual or perceived amplitude values and the desired amplitude values for all compared frequencies between 20 Hz and 20 KHz. In each of these embodiments, the reference frequency values for processing may be low-range, midrange, and/or high-range frequencies. For example, in some embodiments, selected frequencies may be spaced apart evenly within the 1-5 kHz range (e.g., at 1.00 kHz, 1.33 kHz, 1.67 kHz, 2.00 kHz, etc.), or select frequencies may be intermittent based on an estimate where the largest discrepancies exist between the perceived frequency response and the recommended sine sweep intended by the manufacturer for any particular set of headphones. In one example using FIG. 1 as a reference, the tuning system 68 may be designed to tune more frequencies within the range of about 3 kHz to 5 kHz, as these are the frequency ranges with the largest discrepancy values illustrated in FIG. 1. In this respect, in some embodiments, the tuning system 68 may be programmed in one quarter increments between 1 kHz and 3 kHz (e.g., 1 kHz, 1.25 kHz, 1.50 kHz, etc.), and then spaced apart at shorter intervals between 3 kHz and 5 kHz, such as in one tenth increments (e.g., 3.0 kHz, 3.1 kHz, 3.2 kHz, etc.). Here, the tuning system 68 is able to more specifically tune a finer range of midrange frequencies within a range having larger discrepancies, and tune fewer frequency ranges where the discrepancies are anticipated to be smaller.

In some embodiments, one or more low-range frequencies and their desired amplitudes may also be stored to serve as reference data points relative to the other desired amplitudes and their respective frequencies (e.g., midrange frequencies). In some embodiments, the one or more reference frequencies may be low-range unison tones, and the amplitude of these low-range reference frequencies may help provide the desired tuning to the earbud 42 in later steps of the process (800). This is because there are relatively few discrepancies between the reference frequency response sine sweep 12 and the perceived sine sweep 14 in the low-range frequency range of, e.g., about 100 Hz to 500 Hz. To this end, playing low-range frequencies at a certain amplitude can be used to determine and program discrepancies in amplitude between the desired frequency response and perceived frequency response in the mid-range frequencies, e.g., as discussed in detail above with respect to FIGS. 1-6. In some embodiments, the low-range reference frequency may be optional because the microphone 44 may be configured and programmed to accurately detect the actual amplitude of sound being produced at certain frequencies, whereby the tuning system 68 may be able to tune the earbud 42 without comparing the amplitude of low-range reference frequencies with mid-range frequencies.

In step (804), the process (800) involves coupling at least one earbud 42 to the ear 50 of the user, such as by methods well known in the art. In some embodiments, the earbud may be the earbud 42 illustrated in FIGS. 7A and 7B capable of forming the seal 62 at the opening of the car canal 56 for creating the closed tube resonator within the ear canal 56, as mentioned above. Here, the speaker 46 and the microphone 44 are able to interface with the ear canal 56 so that the speaker 46 is able to direct the desired sound waves 58 therein, and the modified sound waves 66 are thereafter captured by the microphone 44 so as to record the actual tone (e.g., amplitude and frequency) resonating toward the eardrum 64 of the ear 50. As such, the earbud 42 can be used to calibrate the amplitude of certain frequencies for the ear 50. In embodiments where a pair of the earbuds 42 are used in each ear, the tuning system 68 can calibrate the amplitude of certain frequencies for both user cars simultaneously.

The location of the microphone 44 in the ear-tip 48 relative to the speaker 46 (FIG. 7B) may vary in different embodiments. In some embodiments, e.g., as illustrated in FIG. 7B, the microphone 44 may be at the center of and generally concentric within the interior of the ear-tip 48, thereby being generally oriented toward the ear canal 56 out through the cavity 60 in the ear-tip 48. As a result, the microphone 44 may have a similar position relative to an opening of the car canal 56 as the speaker 46. Although, the microphone 44 may be located in other positions relative to the speaker 46, such as off-center. In other embodiments, the microphone 44 may be directly coupled to the ear 50 (e.g., inside the ear canal 56), including being oriented toward an interior of the ear canal 56. Additionally, the microphone 44 may be detachable from the speaker 46, wherein the user may select the position of the microphone 44 relative to the speaker 46. In other embodiments, the microphone 44 may be completely separate from the earbud 42 or otherwise integrated with the earbud 42.

The next step (806) in the process (800) is to play sound using the speaker 46, and within the closed tube resonator formed by sealing off the ear canal 56 with the earbud 42, at least at the frequencies and/or frequency ranges desired to be tuned with the earbud 42. In some embodiments, the frequencies and/or frequency ranges desired to be tuned may be retrieved from the memory unit 72 (FIG. 10) for playback within the earbud 42. The audio tones played by the speaker 46 may be in the form of one or more discrete frequencies or one or more frequency ranges as disclosed with respect to step (802).

In some embodiments, the process (800) may play discrete frequencies at the desired amplitudes for a constant and/or equal time intervals relative to one other (e.g., between 0.1-10 seconds). In other embodiments, the discrete audio frequencies may be played at varying time intervals. In embodiments where a low-range reference frequency is also used for tuning, the low-range reference frequency may be played first to help determine the desired amplitude of other frequencies, such as mid-range frequencies. In some embodiments, the reference frequency may be played for a shorter or longer time interval than the other discrete frequencies being tuned and/or the reference frequency may be played only once before playing the actual frequencies to be tuned. Alternatively, the reference frequency may be played each time before a discrete midrange frequency is played, which may enhance accuracy in the later tuning steps. In some embodiments, the reference frequency may be a low-range unison frequency.

In other embodiments, the process step (806) may play tones in one or more frequency ranges instead of discrete frequency values. Here, lower frequency ranges may be played before the higher frequency ranges, and vice versa. In embodiments where a frequency range is played instead of discrete frequency values, such a range (or ranges) and the corresponding amplitudes may be played in a continuous time interval, e.g., without pausing. In some embodiments, the amount of time a certain tone in the frequency range is played may be as low as fractions of a second (e.g., 1-999 milliseconds), or as high as several seconds (e.g., 1-5 seconds). The longer the tone in the range is played (e.g., one or more seconds), the more data may be recorded and compared in later steps, such as in step (810). Obtaining more datapoints may result in extending the duration for the process (800) to complete, but the correction to the user experienced frequency response may be more accurate in relation to replicating the desired reference frequency response within the earbud 42. Alternatively, playing the tone for a shorter duration (e.g., in milliseconds) may result in the process (800) ending faster, but tuning may be less accurate.

In some embodiments, the same frequency range may be played more than once to enhance the recording and tuning accuracy, i.e., obtaining more datapoints is designed to decrease the extent the system 68 needs to extrapolate between tuned frequencies. In other words, obtaining more datapoints may help fine tune the experienced frequency response to more closely match that of the desired reference frequency response.

In some embodiments, where multiple frequency ranges are played for tuning, each frequency range may be played one after the other, either with or without a silent pause in between. Additionally, the playing step (806) may involve playing music for a duration comparable to that of listening to a song with the earbud 42.

The next step (808) in the process (800) is to record the actual amplitudes experienced within the closed tube resonator of the ear canal 56 using the microphone 44. As briefly mentioned above, and shown in FIG. 7B, certain audio frequencies (e.g., the desired sound waves 58) being played by the earbud 42 in step (806) may be perceived by the microphone 44 (and ultimately the user) at different amplitudes (e.g., the modified sound waves 66) than those intended by the manufacturer of the earbud 42. This is typically the result of the unique ear anatomy of each human ear canal, e.g., differences in the canal length 52 and the variable diameter 54 there along. In fact, the structure of the ear canal for each ear of a user is oftentimes different, whereby the user may experience sounds in each ear differently. Here, in one embodiment, the location and structure of the microphone 44 relative to the ear-tip cavity 60 may be designed to orient the microphone 44 toward or within the ear canal 56 of the ear 50 for purposes of recording sound as close to how the eardrum 64 experiences the sound as possible. The location of the microphone 44 may be designed to identify the amplitude of frequencies that are comparable and/or otherwise the same as the amplitudes being experienced by the user (e.g., the modified sound waves 66). In some embodiments, the system 68 may perform the playing step (806) and the recording step (808) simultaneously, or as part of discrete separate steps.

In other embodiments, the microphone 44 may record the amplitude of certain frequencies within the closed tube resonator formed within the ear canal 56 between the earbud 42 and the eardrum 64 while music is being played by the speaker 46, as opposed to the speaker 46 playing certain discrete frequencies for purposes of tuning only. The recordings captured as part of step (808) may be stored in one or more of the memory unit(s) 72 (FIG. 10) for later use in comparing the perceived amplitudes at certain frequencies (e.g., the modified sound waves 66) with the desired amplitudes (e.g., the desired sound waves 58) the manufacturer of the earbud 42 desires the listener to experience.

In some embodiments, the system 68 may record a discrete number of amplitudes with the microphone(s) 44 at certain predefined frequencies, e.g., as disclosed above with respect to step (802) and/or discussed elsewhere herein. In this respect, the system 68 could record the amplitude of thousands of frequencies, some of which may vary in relatively small incremental values relative to one another. Here, the system 68 may be limited only by current processing power of the microcontroller 70 and/or capabilities (e.g., size and speed) of the memory units 72. As such, the more datapoints the system 68 captures with the microphone(s) 44, the more granular the adjustments the system 68 can make to more accurately modify the perceived frequency response to match that of the desired manufacturer reference frequency response. In other embodiments, the system 68 may record one or more amplitude ranges, corresponding to one or more frequency ranges, with the microphone(s) 44 at certain predefined frequencies, e.g., as disclosed above with respect to step (802) and/or discussed elsewhere herein.

As also discussed above, the sine sweep 14 illustrated in FIG. 1 provides one example how data collected as part of step (808) may be graphically represented in relation to the reference frequency response (i.e., illustrated as the sine sweep 12 therein). Here, the measurements obtained by the microphone 42 in step (808) of the actual amplitudes of the one or more discrete frequencies are mapped on an amplitude versus frequency graph against the reference or desired frequency response shown therein, e.g., with respect to the first sine sweep 12. Plotting the actual amplitudes captured by one of the microphone(s) 44 at certain desired frequencies (e.g., the sine sweep 14) against the desired frequency response of the manufacturer (e.g., the sine sweep 12) provides an exemplary illustration how the microphone(s) 44 can be used to identify discrepancies between the frequency response the user experiences and the desired frequency response intended by the manufacturer of the earbud 42, including the amplitude discrepancies that tend to be the largest within the 1 kHz to 5 kHz range.

In step (810), the process (800) compares the actual amplitude values identified with the microphone 44 with the amplitude values of the desired frequency response, at each corresponding frequency. Specifically, the amplitude values for certain frequencies loaded into the system 68 as part of the step (802) are compared against the amplitude values recorded as part of the step (808) on a frequency-by-frequency basis. This way, the system 68 can determine if there are any differences between the amplitude values of the desired frequency response and the amplitude values measured by the microphone 44. In some embodiments, the comparison may be done locally by the microcontroller 70 (FIG. 10) in combination with one or more of the memory unit(s) 72.

For illustration purposes, the amplitude versus frequency graph of FIG. 1 illustrates how the frequency values between the reference frequency response (e.g., illustrated as the sine sweep 12) could be plotted against the perceived frequency response (e.g., illustrated as the sine sweep 14) measured by the earbud 42, as part of the tuning process (800). In some embodiments, the graph could be presented to the user graphically, such as by way of a graphical user interface 74 (FIG. 10).

While FIG. 1 illustrates the relationship between the sine sweep 12 and the sine sweep 14 in a range of frequencies between about 20 Hz and 20 kHz, in other embodiments, such a graph may illustrate smaller frequency ranges (e.g., only those with the largest discrepancies in the 1 kHz to 5 kHz range) or one or more intermittent discrete values within the full range of 20 Hz and 20 kHz. The graph may also depict the comparison in linear and/or non-smooth linear progressions. Here, such linear progressions may correspond to discrete frequency values rather than frequency ranges. While the comparison may be plotted for visual inspection through the graphical user interface 74, in other embodiments the microcontroller 70 may execute the comparison without producing any such visual representation. In the latter embodiment, the system 68 may proceed directly to step (812) after finishing the comparing step (810) without preparing or displaying a graph or plot.

Using one or more low-range reference frequencies as additional data points may help confirm the accuracy of the comparison between the first sine sweep 12 and the second sine sweep 14 because the system 68 can use the relatively low-range reference frequencies as a reference when determining the discrepancy value at higher frequencies (e.g., mid-range frequencies between 1 kHz and 5 kHz), similar to that disclosed above with respect to the embodiments illustrated in FIGS. 1-6. As such, one or more relatively low-range reference frequencies (e.g., in the 20 Hz to 800 Hz range where FIG. 1 illustrates the most overlap between the first sine sweep 12 and the second sine sweep 14) may be used to help validate what the microphone 44 recorded for other frequencies having a relatively higher discrepancy value between the first sine sweep 12 and the second sine sweep 14. Conducting such a comparison may help determine if there were any technical errors with the microphone recording.

Once the comparison is finished per step (810), the next step (812) is to generate a corrective output that includes adjustments to the amplitudes of the second sine sweep 14 at certain frequencies that differ from the amplitudes of the same or comparable frequencies of the first sine sweep 12. As such, the discrepancy values are used to adjust the amplitude of certain frequencies within the second sine sweep 14 to match the amplitude the manufacturer intended for the listener to experience with the earbud 42. The corrective output may be linear (e.g., transfer function), non-linear (e.g., non-linear audio processing), or a combination thereof. The microcontroller 70 may generate the corrective output by comparing information stored in one or more of the memory units 72.

The corrective output may be in the form of a transfer function serving as an equalizer that transforms the actual amplitudes closer, or equal, to the desired amplitudes in subsequent usage of the earbud 42. More than one transfer function may be generated if amplitudes (desired and actual) from more than one frequency range were compared in the previous steps. The transfer function may have a Q value that helps filter what portion of the frequency range are modified by the transfer function. A low Q value (e.g., 1-2) may allow the transfer function to affect a large frequency range where a high Q value (e.g., 5-10) may narrow the frequency range. Moreover, the corrective output may be the result of non-linear audio processing that reshapes, modulates, compresses, or clips the amplitudes of certain frequencies so they more closely match the desired amplitudes as per the desired or reference frequency response. Non-linear audio processing may be more dynamic than a linear corrective output, and may be time-variant or time-invariant. The non-linear audio processing may reshape the tone produced by the earbud 42 by more than adjusting the amplitude value at a certain frequency.

In step (814), the process (800) applies the corrective output to adjust the amplitude values read by the microphone 44 to be similar to or the same as the desired or reference amplitude values at comparable frequencies. Such adjustments to the second sine sweep 14 (or at least a portion thereof) otherwise representing the actual amplitudes picked up by the microphone 44 during tuning, better tracks that of the first sine sweep 12. Thereafter, with such adjustments applied in real-time when playing music, the user will experience sound with the earbud 42 more closely to that intended by the manufacturer. This may be because the sound waves now produced by the headphone speaker 46 (FIG. 7B) are tailored to the anatomy of the car canal 56 of the user. Of course, the corrective output may raise or lower the amplitude value of the audio produced by the earbud 42 at certain corresponding frequencies to compensate for any excess or shortage of volume for the user to experience the desired frequency response. The corrections by the system 68 to the output are designed to equalize the amplitude values of the frequencies where the actual amplitude values do not appear to equal the desired amplitude values, whether such frequencies may be discrete values or in a frequency range. In some embodiments, the corrective output may be stored in one or more of the memory units 72 and applied by the microcontroller 70 (FIG. 10) in real-time when playing sound through the earbud 42. The corrective output may alter some or all amplitude values for select discrete frequencies and/or frequency ranges. Such considerations may depend on the type of corrective output being used in step (814) (e.g., linear or non-linear audio processing).

In some embodiments, the user interface 74 may also be used to manually make adjustments to the corrective output and otherwise calibrate the earbud 42, similar to that discussed above with respect to FIGS. 1-6. In this embodiment, the user may be able to select certain frequencies for further tuning, including those frequencies that may be intermediate those that were automatically configured as part of the process (800). This may help fill in gaps between frequency values that were tested and those that were not tested. After performing this additional manual calibration, in subsequent usage of the earbud 42, the user may experience a more optimal frequency response intendent by the manufacturer as the earbud 42 is now more highly customized to the inner ear anatomy of that particular user.

In one embodiment, a single corrective output may be stored for one user of the earbud 42. Alternatively, or in addition to, a pair of corrective outputs may be stored for a single user of the earbud 42, one calibrated for each ear. Moreover, the earbud 42 may also store multiple corrective outputs for use with more than one user. This feature may be used when the earbud 42 is used by several different persons, e.g., in one family. Once the one or more corrective outputs are applied to adjust the actual audio experienced by the user to the desired frequency response, the process ends in step (816).

FIG. 9 illustrates a flowchart of a process for real-time headphone tuning (900).

Instead of storing the desired amplitudes and the actual amplitudes at different frequencies for later comparison to generate a corrective output, the actual amplitude may be corrected in real-time to match the desired amplitude as part of the process (900). Here, headphone tuning may be accomplished by analyzing and correcting an audio data stream generated in real-time rather than using stored data, some of which may have been previously recorded. Generally, the microphone 44 measures the amplitude of frequencies playing within the ear canal 56 by the speaker 46 in real-time, and those values are relayed to the microcontroller 70 for comparison against the amplitudes of the desired frequency response. The microcontroller 70 identifies the discrepancy between the perceived amplitudes and the desired amplitudes, and adjusts the amplitude of the sounds playing at certain frequencies through the speaker 46 accordingly.

More specifically, the first step in the process (900) is to load a reference frequency response having desired amplitude values for different sound frequencies as part of a step (902). The desired amplitude values for the reference frequency response may be for a discrete number of frequencies, or one or more frequency ranges, similar to that described above with respect to step (802). In some embodiments, the process (900) may store the desired amplitudes for all frequency ranges audible to humans, to help facilitate a thorough real-time tuning of the earbud 42. In these embodiments, a reference frequency may not be needed to complete the steps in process (900) because tuning is done largely in real-time based on amplitude measurements from the microphone 44. In other words, the microphone 44 may be able to pick up and determine the amplitude of certain frequencies without the need to compare the amplitude of the frequency being played against the amplitude of a reference low-range frequency. In some embodiments, the amplitudes of the desired frequency response may be stored in one or more of the memory unit(s) 72 (FIG. 10).

Similar to the above, the next step (904) in the process (900) may involve coupling the earbud 42 and the microphone 44 to the ear 50 of the user. In step (906), the process (900) may play the sound frequencies at the desired amplitude values using the earbud 42, similar to what was described above with respect to step (806) of the process (800). The desired amplitudes may be those stored in step (902) and correspond to discrete frequency values or one or more frequency ranges. In step (908), the process (900) may record the actual amplitudes resonating towards the ear drum 64 of the user at their corresponding frequencies, similar to what was described in step (808) of process (800). Here, the recording of step (908) may be in the form of a real-time data stream of audio signals, and facing the microphone 44 toward the ear-tip cavity 60 of the earbud 42 (FIG. 7B) and toward the ear canal 56 and the eardrum 64 is designed to record the actual amplitudes (e.g., from the modified sound waves 66) the user experiences within the ear canal 56. One difference between the process (800) and the process (900) is that the recorded data stream in step (908) may be sent for real-time analysis, e.g., by the microcontroller 70.

The next step (910) is for the system 68 to determine whether the actual amplitudes at certain frequencies being sensed by the microphone 44 are approximately equal to the desired amplitudes of the reference frequency response. Such determination may be done by analyzing the real-time audio signal generated by the microphone 44 to determine whether the actual amplitude reading at a certain recorded frequency in step (908) equals the desired amplitude of the same frequency loaded into the system 68 in step (902). The real-time determination of step (910) may use a data stream of actual amplitudes rather than recorded and/or stored data. The data comparison and determination may be done within a matter of milliseconds (e.g., 1-999 milliseconds) or seconds (e.g., 1-3 seconds). The amplitude comparison may occur within the duration of time that the tone is being played as part of the step (906) and/or recorded as part of the step (908). The real-time data comparison may also be done by the microcontroller 70 and the data about the desired amplitudes may be retrieved from one or more of the memory unit(s) 72.

Step (910) may be accomplished by comparing the actual amplitude value (e.g., in decibels) for a select frequency (e.g., in Hz or kHz) sensed by the microphone 44 from within the data stream to the desired amplitude value (e.g., also in decibels) stored in connection with the desired frequency response as part of the step (902). Such a comparison may also be accomplished by comparing relative amplitudes within certain predefined frequency ranges as well. Such determination may discern whether the actual amplitude value is higher or lower than the desired amplitude value at a corresponding frequency, or within certain frequency ranges. If one or more actual amplitude values do not equal the desired amplitude values, the system 68 assigns a discrepancy value (e.g., in decibels) to each frequency, and the process proceeds to step (912) where the system 68 adjusts the audio played back through the speaker 46 by the discrepancy value for each frequency. In some embodiments, the system 68 may concentrate this comparative analysis within frequency ranges that are known to have larger deviations, such as in the 1-5 kHz range, as disclosed herein. Adjustments to the audio played back through the earbud 42, and specifically the amplitudes of certain frequencies that deviate from the desired reference frequency, may be made in real-time. In some embodiments, the amplitude adjustment(s) may be made within a matter of milliseconds (e.g., 1-999 milliseconds) or seconds (e.g., 1-3 seconds) of when the system 68 determines there is a discrepancy. The amplitude adjustment may be done within the duration of time that the tone is being played (e.g., as in step (906)) and recorded (e.g., as in step (908)).

If it is determined in step (910) that the value of the actual amplitude is lower than the desired amplitude (i.e., by some discrepancy value), then the amplitude value generated by the earbud 42 may be increased by that discrepancy value as part of the step (912). This adjusts the amplitude of the sounds being experienced by the user to more closely match the desired frequency response. If it is determined in step (912) that the value of the actual amplitude is higher than the desired amplitude, then the amplitude value generated by the earbud 42 may be decreased by the discrepancy value as part of the step (912), and vice versa. This is to adjust down the excess amplitudes the user may be experiencing at these frequencies, or within these frequency ranges. In some embodiments, the microcontroller 70 may execute such adjustments in real-time as sound is being played within the earbud 42.

To verify the one or more adjustments made in real-time by the system 68 as part of the step (912), the process (900) may repeat steps (908) and (910), namely recording one or more of the actual (and possibly now adjusted) amplitudes resonating within the ear canal 56 using the microphone 44, as part of the step (908), and then again comparing those one or more actual (and possibly already or further adjusted) amplitudes to the amplitudes of the desired reference frequency response (loaded in step (902)), as part of the step (910). To the extent differences continue to exist between the recorded amplitude(s) at certain frequenc(ies), steps (912), (908), and (910) may continue to repeat until those discrepancies are reduce by a certain amount and/or largely eliminated. In this respect, the system 68 may adjust one or more discrete frequencies, or a plurality of frequencies within a predefined frequency range. In some embodiments, the system 68 may first concentrate on making adjustments within certain frequency ranges known to have larger discrepancies, such as in the 1-5 kHz range, and then move to lower priority frequencies and/or frequency ranges.

Once the process (900) verifies in step (910) that the amplitudes being recorded in step (908), and possibly adjusted as part of the step (912), equal or otherwise generally correspond with the amplitude(s) of the desired reference frequency response, the process (900) may then proceed to step (914) where the amplitude adjustment at the corresponding frequency is stored (e.g., in one or more of the memory units 72) for use playing back music or other sounds for that particular user. In some embodiments, some of the steps of processes (800) and (900) may be combined or substituted for one another to make a hybrid process.

In alternative embodiments, the adjusting step (912) may only run once, e.g., after the system 68 adjusts the amplitudes of one or more frequencies, to the extent needed, the information may be stored as part of the step (914) without further processing. This option may be used in circumstances where the earbud 42, or other processing equipment, may be operating on a battery or other low power state. Once the amplitude adjustments (if any) are stored as part of the step (914), the process (900) may then finish in step (916).

FIG. 10 illustrates a block diagram of the tuning system 68, which may be used in executing the processes (800) and/or (900) of FIGS. 8-9, as discussed above. The tuning system 68 may execute some or all of the steps in the processes (800) and/or (900), and may be a standalone system (e.g., remotely wired or otherwise in wireless communication with the earbud 42), or may be integrated into the earbud 42 and in direct communication with the microphone 44 and/or the speaker 46.

The microphone 44 may be coupled to the earbud 42 and integrated therewith, similar to that illustrated in FIG. 7A, and the microphone 44 may be positioned to face the ear-tip cavity 60 of the earbud 42, similar to that illustrated in FIG. 7B. Alternatively, the microphone 44 may be directly coupled to the ear 50, such as within the ear canal 56, or outside the ear canal 56 and facing in thereof. In some embodiments, the earbud 42 having the microphone 44 coupled thereto may communicate with the system 68 by wireless communication standards, such as Bluetooth, NFC, Wi-Fi, etc. In any of these embodiments, the microphone 44 may be able to detect the audio amplitude and frequency ranges on the vertical and horizontal axes shown in FIG. 1, and may be wired to or otherwise in wireless communication with the tuning system 68, including the earbud 42 and/or the microcontroller 70. Wireless communication may provide convenient coupling with the earbud 42, whereas a wired connection may provide faster and/or more stable/reliable audio signal transmission and/or processing.

In one embodiment, the microphone 44 may be a MEMS microphone having a volume between 1-10 cubic mms and a footprint between 1-8 square mms. Alternatively, the MEMS microphone may have a volume less than 1.00 cubic mms and a foot print less than 1.00 square mms. In other embodiments, the microphone 44 may be an electret condenser microphone having a volume between 10-30 cubic mms and a footprint between 10-20 square mms. Although, the electret condenser microphone may alternatively have a volume less than 10 cubic mms and a footprint less than 10 square mms. An audio sensor (e.g., a decibel meter) may also be used in place of the microphone 42.

The one or more microcontrollers 70 may include one or more of a digital signal processor, a central processing unit, and/or a graphic processing unit, where the microcontroller 70 may execute one or more of the steps of processes (800) and (900) to effectuate real-time adjustment, generating corrective output, etc. In other embodiments, the microcontroller 70 may be substituted by a microcontroller that may be integrated with the earbud 42. In some embodiments, the system 68 may also use a sound card to assist with audio processing. Additionally, one or more of the steps of the processes (800) and (900) may be AI-driven and, thus, the microcontrollers 70 may include a neural processing unit and/or a tensor processing unit.

The one or more memory units 72 may include one or more of RAM and/or non-volatile storage (e.g., ROM, SSD, flash memory, etc.). The memory units 72 may include digital signal processor memory and cache memory, which may help real-time processing of the processes (800) or (900). The user interface 74 may be used to display the outputs of the system (e.g., graph similar to FIG. 1) and allow a user to interact with the system (e.g., commanding the system to execute one or more of the steps of the processes disclosed herein). The user interface 74 may be a display screen (e.g., touchscreen) or a monitor, mouse, and/or keyboard.

Although several embodiments have been described in detail for purposes of illustration, various modifications may be made without departing from the scope and spirit of the invention. Accordingly, the invention is not to be limited, except as by the appended claims.

What is claimed is:

1. A process for tuning a headphone, comprising the steps of:
loading a desired amplitude value for at least one audio frequency;
coupling the headphone to a user so a microphone associated therewith is positioned proximate an ear canal of the user;
playing the at least one audio frequency at the desired amplitude value with the headphone;
recording a perceived amplitude value for the at least one audio frequency with the microphone;
comparing the perceived amplitude value with the desired amplitude value for the at least one audio frequency; and
altering play back of the at least one audio frequency to a modified amplitude value the microphone identifies as closer in value to the desired amplitude value than the perceived amplitude value.

2. The process of claim 1, including simultaneously performing the playing, recording, comparing, and altering steps with the headphone having a pair of microphones and a pair of speakers, each of which are independently associated with one of a pair of ears of the user.

3. The process of claim 2, wherein the altering step includes reproducing the at least one audio frequency at a pair of modified amplitude values that are different for each of the pair of ears of the user.

4. The process of claim 1, including the step of altering between the playing and the recording steps.

5. The process of claim 1, wherein the playing step includes emitting music from a speaker in the headphone.

6. The process of claim 1, including the steps of selecting a frequency different than the at least one audio frequency and manually adjusting an amplitude of the selected frequency with a graphical user interface.

7. The process of claim 1, wherein the at least one audio frequency comprises a set of discrete frequencies or a frequency range.

8. The process of claim 7, wherein the set of discrete frequencies comprises between 2 and 1,000 frequencies.

9. The process of claim 7, including the step of selecting the frequency range based on at least 80% of the frequencies within the frequency range being within one standard deviation of the mean difference between the perceived amplitude value and the desired amplitude value of all compared frequencies between 20 Hz and 20 kHz.

10. The process of claim 7, wherein the frequency range comprises a low frequency range between 20 Hz to 800 Hz, a mid-frequency range between 1-5 kHz, or a high-frequency range comprising frequencies greater than 6 kHz.

11. The process of claim 1, wherein the at least one audio frequency includes a reference audio frequency having a reference desired amplitude value the same as a reference perceived amplitude value produced by the headphone at the reference audio frequency.

12. The process of claim 1, including the step of generating a corrective output based on the modified amplitude value having a transfer function with a Q value.

13. The process of claim 12, wherein the corrective output comprises a linear audio processing output or a combination of the linear audio processing output and a non-linear audio processing output.

14. The process of claim 1, wherein the altering step includes the step of playing multiple audio frequencies at their respective modified amplitude values.

15. The process of claim 1, including the steps of saving the modified amplitude value for the at least one audio frequency for a first user and saving a second modified amplitude value for the at least one audio frequency for a second user.

16. The process of claim 1, including the steps of selecting a reference frequency response and changing the desired amplitude value to a new desired amplitude value corresponding with the selected reference frequency response.

17. A process for tuning a headphone in real-time, comprising the steps of:
storing a set of reference amplitude values for a set of audio frequencies;
positioning a microphone associated with the headphone proximate an ear of a user;
playing the set of audio frequencies at the set of reference amplitude values; and
adjusting playback of the reference amplitude values in real-time by a discrepancy value comprising a difference between the reference amplitude value and a perceived amplitude value measured by the microphone for each of the set of audio frequencies.

18. The process of claim 17, wherein the adjusting step includes the step of comparing the reference amplitude value to the perceived amplitude value.

19. The process of claim 17, wherein the adjusting step occurs within milliseconds of the playing step.

20. The process of claim 17, wherein the set of audio frequencies comprises a discrete number of frequencies or a frequency range.

21. The process of claim 20, wherein the frequency range comprises 1-5 kHz.

22. The process of claim 17, including the steps of repeating the playing and adjusting steps and creating a respective modified amplitude value for each of the set of audio frequencies perceived by the microphone to be closer in value to the respective reference amplitude value than the perceived amplitude value.

23. An audio tuning system, comprising:
a headphone selectively attachable relative to an ear canal;
a speaker coupled with the headphone and positionable relative to the ear canal to direct a set of sound waves therein; and
a microphone positionable relative to the ear canal to capture and record the set of sound waves from the speaker at amplitudes comparable to that perceived by the ear canal.

24. The system of claim 23, wherein the headphone comprises an earbud or a set of over-ear headphones.

25. The system of claim 24, wherein the microphone is integrated within the earbud and selectively positionable within the ear canal when the earbud is coupled to an ear.

26. The system of claim 25, wherein the earbud includes an ear-tip having a size and shape to form a seal with an ear canal to form a closed tube resonator therein.

27. The system of claim 26, wherein the microphone is positioned to face an ear-tip cavity of the ear-tip.

28. The system of claim 23, wherein the microphone comprises an ultra-miniature microphone having a footprint less than 1 square millimeter.

29. The system of claim 23, wherein the microphone includes an integrated sound level meter and the headphone includes a wireless or wired communication circuit.

30. The system of claim 23, wherein the microphone is selectively detachable from the headphone.

31. The system of claim 23, including a graphical user interface having a communication circuit communicable with the audio tuning system and including at least one control for adjusting an amplitude of an audio frequency produced by the speaker.
